(19) United States
(12) Patent Application Publication
(10) Pub. No.: US 2014/0317843 A1
(43) Pub. Date: Oct. 30, 2014

(54) PATIENT LIFTING DEVICE USING TAKE-UP ROLLERS

(71) Applicant: Willis E. Martin, Rocky Mount, NC (US)

(72) Inventor: Willis E. Martin, Rocky Mount, NC (US)

(21) Appl. No.: 14/260,635

(22) Filed: Apr. 24, 2014

Related U.S. Application Data
(60) Provisional application No. 61/816,397, filed on Apr. 26, 2013.

(51) Int. Cl. A61G 7/10

(52) U.S. Cl. CPC A61G 7/1051
USPC 5/87.1; 5/88.1

(57) ABSTRACT

A patient lift device comprises a mobile frame and a pliable sheet or support for supporting or manipulating a patient. A pair of spaced apart elongated rollers is operatively connected to opposite sides of the sheet. By rotating the rollers, the sheet with the patient lying thereon can be raised or lowered, or by selectively rotating one or both rollers, the patient can be turned or manipulated.

This application claims priority under 35 U.S.C. §119(e) from the following U.S. provisional application: Application Ser. No. 61/816,397 filed on Apr. 26, 2013. That application is incorporated in its entirety by reference herein.

### FIELD OF THE INVENTION

The present invention relates to patient lifting devices, and more particularly to a patient lifting device that is capable of lifting, lowering and manipulating a patient.

### BACKGROUND OF THE INVENTION

One of the most challenging problems facing the healthcare industry today is that of safely handling patients that are not mobile. As discussed in my co-pending application, U.S. patent application Ser. No. 12/963,837 and entitled “Patient Lifting Device”, the task of safely and correctly lifting patients is difficult from at least two viewpoints. First, it is important to lift the patient or injured person without further injuring the person or aggravating an existing injury. Secondly, and what may be surprising to many, it is important to lift the person or patient without injuring the nurses, EMT/EMS personnel or other healthcare workers engaged in handling injured patients. The number of injuries suffered by healthcare personnel in lifting patients is huge and, in the end, results in substantial costs incurred simply as a result of healthcare workers being injured while lifting and handling patients.

Therefore, there has been and continues to be a great need for innovation in this particular area of healthcare. More particularly, there is a need for a simple mobile patient handling device that can lift and raise patients and which is capable of moving patients from one area of a healthcare facility to another.

### SUMMARY OF THE INVENTION

The present invention relates to a patient lift device comprising a mobile frame and a pliable sheet or support for supporting or manipulating the patient. A pair of spaced apart elongated rollers is operatively connected to opposite sides of the sheet. By rotating the rollers, the sheet with the patient lying thereon can be raised or lowered, or by selectively rotating one or both rollers, the patient can be turned or manipulated.

In one particular embodiment, the patient lift device comprises a wheel supported frame. A pair of motor-driven spaced apart rollers is mounted on the frame. The pliable sheet includes attachments extending from opposite sides of the sheet. With a patient lying on the sheet, the attachments can be attached to the rollers. By actuating the motors associated with the rollers, the rollers rotate and, in the process, portions of the sheet are rolled onto the rollers. This results in the sheet being lifted with the patient thereon. The sheet and patient can be lowered onto a bed or other support surface by reversing the rotation of the rollers.

Not only can a patient be raised, transported and lowered, but the patient lift device can also be used to turn or manipulate a patient. For example, as discussed herein, a patient lying on his or her back on the sheet can be turned by actuating one roller or by differentially actuating the two rollers such that the sheet effectively turns over manipulates the patient thereon.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of the patient lift device with the patient support or sheet detached from the device.

FIG. 2 is a perspective view similar to FIG. 1 but showing the frame structure of the patient lift device in an expanded configuration.

FIG. 3 is a perspective view of the patient lift device in an expanded position being moved over a bed supporting the sheet and the patient.

FIG. 4 is a perspective view of the patient lift device showing the patient being lifted from the bed and supported on the sheet.

FIG. 5 is a perspective view showing an alternative design for the patient lift device which includes a hinged support or stretcher.

FIGS. 6A and 6B are schematic drawings showing how the rollers and sheet cooperate to raise a patient from a support surface.

FIGS. 7A and 7B show how the sheet and rollers cooperate to turn a patient.

FIGS. 8A and 8B show how the sheet and rollers cooperate to lower a patient onto a bed or support.

FIG. 9 is a perspective view of an alternative embodiment for the patient lifting device.

FIG. 10 is a perspective view of the patient lifting device shown in FIG. 9 but with the patient support being removed from the frame structure.

### DESCRIPTION OF EXEMPLARY EMBODIMENT

With further reference to the drawings, the patient lift device is shown therein and indicated generally by the numeral 100. Patient lift device 100 includes a mobile frame indicated generally by the numeral 12. In addition, the patient lift device includes a patient support indicated generally by the numeral 140. In the embodiments illustrated herein, the patient support is a pliable and flexible structure that can be rolled or taken up by a roller. More particularly, in the embodiments illustrated herein, the patient support comprises a sheet 140A. Sheet 140A is provided with a series of spaced apart connectors or attachments 160 that extend from the opposed side edges of the sheet. Attachments 160 can take various forms. In this embodiment, attachment 160 comprises a series of loops.

Mounted on the mobile frame 12 is a pair of rollers 180. Rollers 180 are elongated and are rotatively mounted on the mobile frame 12. As seen in the drawings, rollers 180 are spaced apart. Rollers 180 can be controlled and driven by various means. In one embodiment, the patient lift device 100 is provided with a pair of direct drive motors 200. The direct drive motors 200 can be DC motors and can be powered by batteries supported by the mobile frame 12. Alternatively, the motors 200 could be AC motors powered by alternating current. In some embodiments, the patient lift device 100 is provided with a single controller 220 that controls the motors 200 which in turn controls the actuation and rotation of the rollers 180.

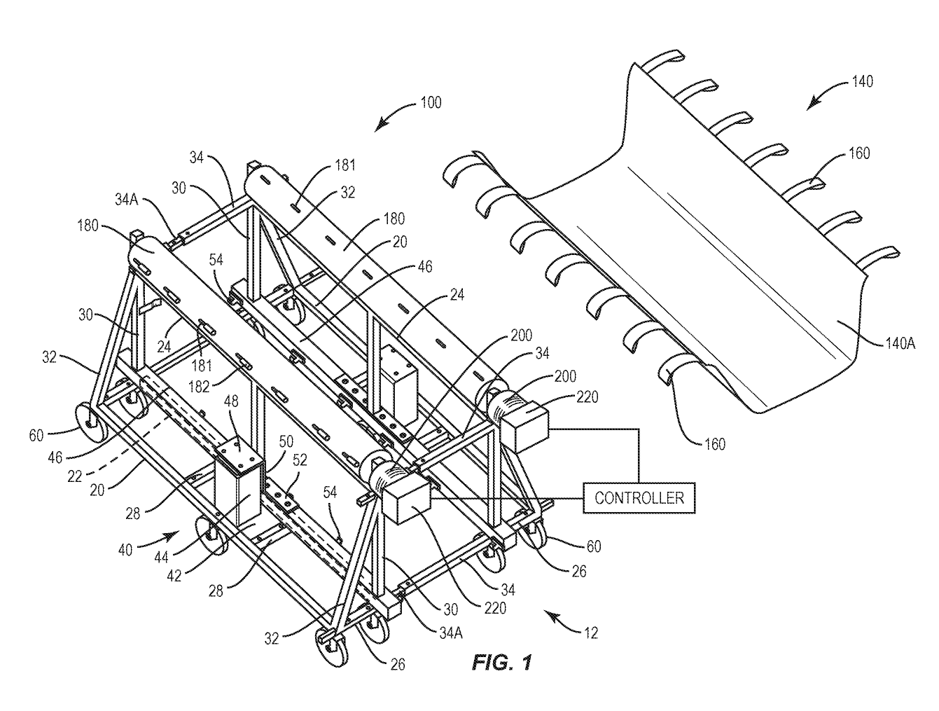

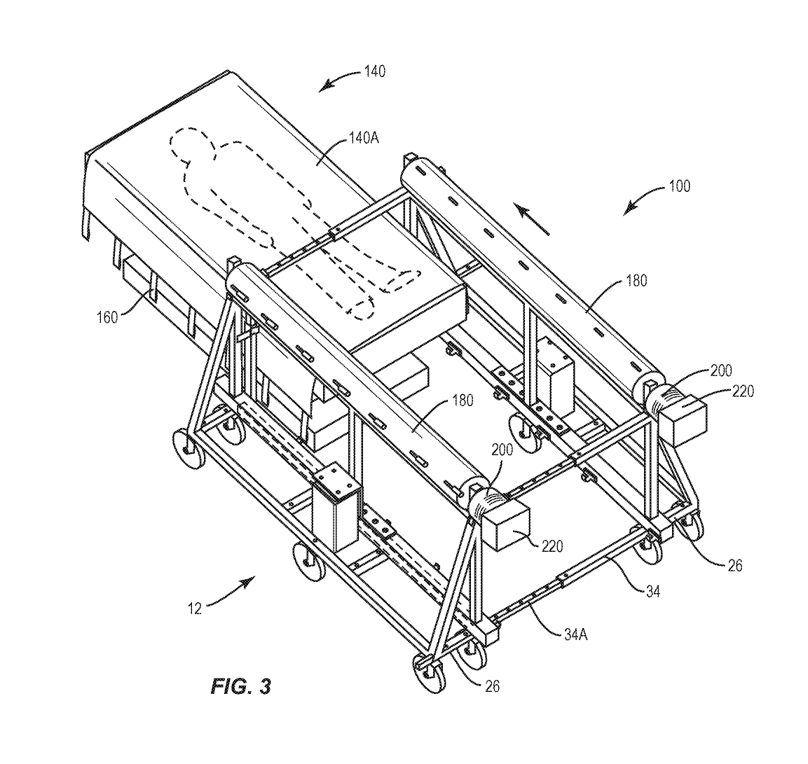

Before moving forward with details of the patient lift device 100, it may be beneficial to briefly review the fundamental operation of the device. As shown in FIG. 3, a patient is supported on the sheet 140A which is in turn supported on a bed, for example. The mobile frame 12 is maneuvered over the bed. Attaching loops 160 are attached to the rollers 180. Thereafter, the motors 200 are actuated. Rollers 180 rotate in counter-directions. As viewed in FIG. 1, the leftmost roller 180 rotates counterclockwise and the right most roller 180 rotates clockwise. This will result in the sheet 140A being raised from the bed and, in the process, the patient is raised with the sheet.

Therefore, from a conceptual point of view, the patient lift device 100 of the present invention utilizes a pliable sheet-like support for underlying a patient and the pliable sheet-like support is connected to two counter-rotating rollers that function to rotate to raise and lift a patient or lower the patient and, in some cases as described below, the rollers can be selectively actuated or controlled to turn or otherwise manipulate the patient.

Returning to a description of the patient lifting device 100, the pliable sheet or patient support 140A can be constructed of various suitable materials, such as cotton, polyester, synthetic materials, etc. Loops 160 projecting from the sides of the pliable sheet 140A can also be constructed of various suitable materials including fabric. Rollers 180 are elongated cylinders and are constructed of various materials such as formed sheet metal or aluminum, for example. Note that rollers 180 include a series of slots 181 formed therein. Slots 180 are paired such that each pair is generally aligned and wherein the pairs of slots are laterally spaced along the axis of the rollers 180. Disposed adjacent the outboard oriented slots (as seen in FIG. 1) are a series of fastening pins 182. Fastening pins 182 function to fasten the loops 160 to the respective rollers 180. That is, the individual loops 160 are inserted from the inboard side of each roller 180 through a first slot and then through a second outboard slot, and thereafter a fastening pin 182 is inserted through the end of the loop. Fastening pins 182 are larger than the slots 181 and, therefore, the respective loops 160 are effectively secured to a respective roller 180.

As noted above, each roller 180 is rotatively mounted on the frame structure 12. In one exemplary design, each roller 180 includes opposed stub shafts extending outwardly from the respective ends of the roller. Each stub shaft is rotatively journaled in a bearing that is supported by the frame structure 12.

In one embodiment there is provided a pair of controllers 220 for controlling the motors 200. In the embodiment illustrated herein, there is shown two controllers 220 but it is understood that a single controller could be utilized to control both motors 200. Controllers 220 are programmed to control various functions of the motors 200, which in turn control various functions of the rollers 180. In the way of examples, controllers 220 could be programmed to control the speed of the motors 200, the number of revolutions or angular rotation of the rollers 180 upon actuation, the direction of rotation of the rollers, start and stop positions for the rollers and the controllers could be provided with a patient turning or manipulation control where the respective rollers 180 are controlled to turn or manipulate a patient in a certain direction and to a certain degree.

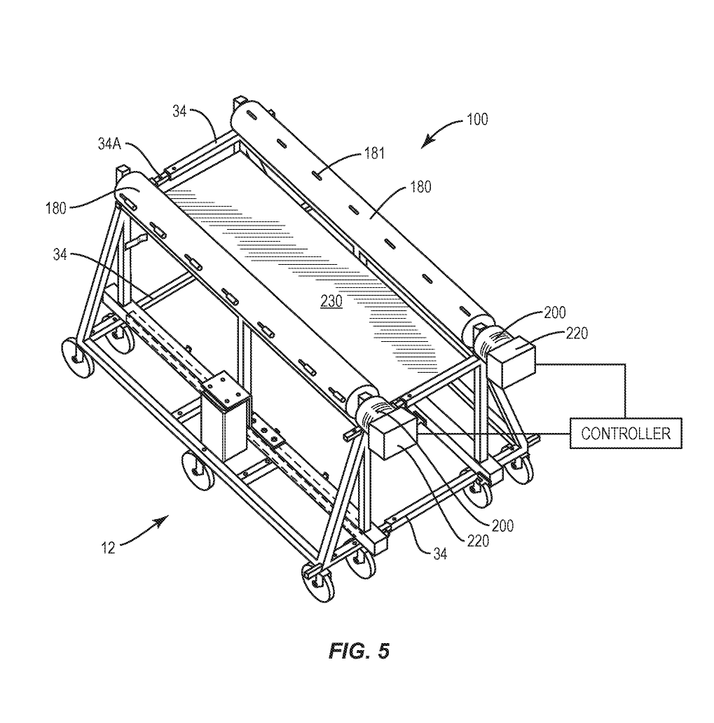

FIG. 5 shows an alternate embodiment for the patient lift device 100 of the present invention. In this case, a support or stretcher 230 is incorporated into the frame structure 12. In this design or embodiment, stretcher 230 is hinged on one side of the frame structure 12 but is connectable to the frame structure on the opposite side. Thus, the stretcher 230 can assume a generally horizontal orientation as shown in FIG. 5 or can simply assume a vertical position with the top edge in that position being hinged to the frame structure 12. In the normal vertical orientation, the stretcher 230 does not encumber or interfere with the use of the pliable sheet or patient support 140A. However, the stretcher 230 can be utilized to provide additional support for a patient disposed on the sheet 140. For example, a patient can be raised to an upper position on the frame structure 12 and once in the upper position, the support or stretcher 230 can be swung from the vertical position to the horizontal position and connected to the frame structure. Thereafter, the rollers can be actuated and the patient can be lowered onto the stretcher 230 where the stretcher provides additional support. In some cases, the stretcher 230 may be designed to be completely detachable from the frame structure 12. In this case, when a patient is supported on the pliable sheet 140A and the pliable sheet is in turn supported on the stretcher 230, both the pliable sheet and the stretcher can be detached from the frame structure and the rollers and the patient, along with the pliable sheet 140A and the stretcher 230 can be removed from the patient lift device 100.

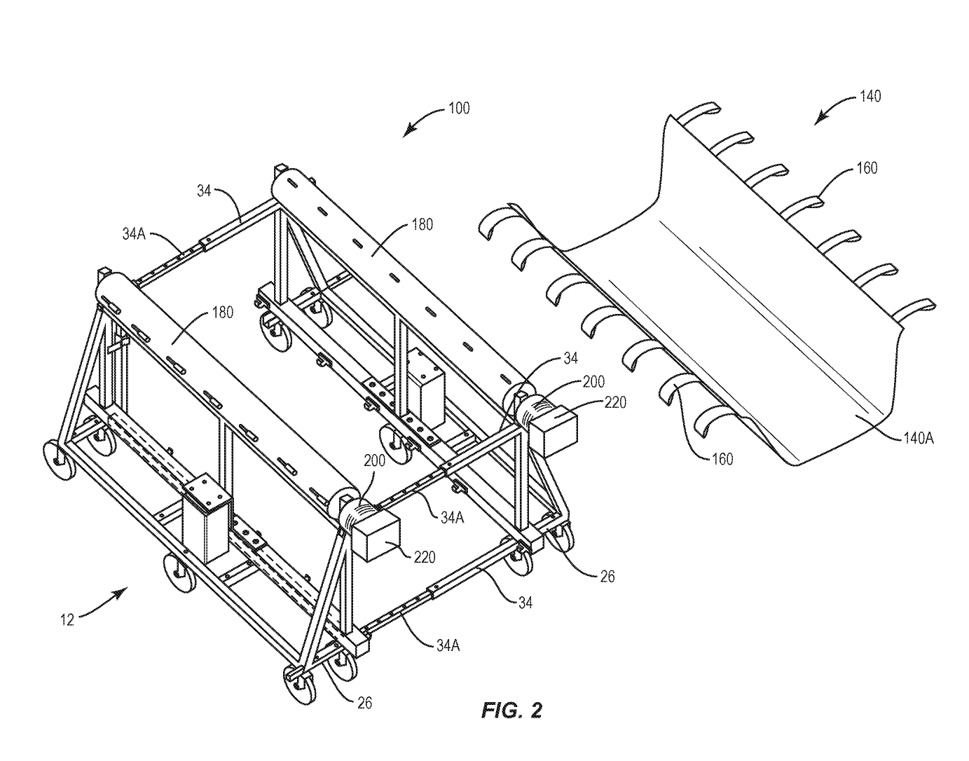

Turning to the mobile frame structure, it is appreciated that various types and forms of frame structures could be employed to support the rollers 180 and the associated structures that engage, lift and manipulate the patient. Disclosed herein is only one embodiment of an appropriate frame structure 12. In the embodiment illustrated in the drawings, the frame structure 12 is made up of two like side sections that are attachable and detachable and the side sections are moveable between a retracted position (FIG. 1) and an extended position (FIG. 2). The following discussion will generally describe one side section of the frame structure, but it is understood that the description of one side section equally applies to both sections of the frame structure.

Each side section of the frame structure includes a pair of spaced apart lower longitudinal runners 20 and 22. In addition, there is provided an upper longitudinal runner 24. A series of cross members extend between the lower longitudinal runners 20 and 22. More particular, about opposite ends of each half section is a lower cross member 26 that connects the lower longitudinal runners 20 and 22. In addition, there is provided a pair of intermediate cross members 28. As will be appreciated from subsequent portions of the disclosure, these intermediate cross members 28 serve to reinforce the basic frame structure 12 but also serve to support a life assembly.

Each side section includes a series of vertical guide posts 30 that extend upwardly between the lower longitudinal runner 22 and the upper longitudinal runner 24. More particularly, there are three vertical posts 30 that extend upwardly from the inner longitudinal runner 22. Vertical posts 30 are longitudinally spaced apart and connected between a respective inner longitudinal runner 22 and the upper longitudinal runner 24. In addition, each side section includes two inclined vertical posts 32. Vertical posts 32 are disposed on opposite ends of the side section. Each inclined vertical post 32 extends from the outer longitudinal runner 20 upwardly to the upper longitudinal runner 24. Thus, it is appreciated that about opposite ends of the side section, the posts 30 and 32 form a generally inverted V-shape.

Secured about opposite ends of one side section is a connecting sleeve 34. Each connecting sleeve 34 is hollow, and as depicted in the drawings, extends generally laterally with respect to one side section. As will be discussed later, these connecting sleeves 34 receive connecting bars that function to connect the two side sections together.

Each side section includes a lift assembly for connecting to an auxiliary support (not shown) and lifting the support and a patient or injured person thereon. The lift assembly associated with each side section is indicated generally by the numeral 40. See FIG. 1. Lift assembly 40 includes a base plate 42. Note that base plate 42 is connected between the intermediate cross members 28 that extend between the lower longitudinal runners 20 and 22. Secured to the base plate 42 and extending upwardly therefrom is a column lift or lifting device 44. Details of the column lift are not shown herein because such is not per se material to the present invention, and further, column lifts are known and commercially used today. In the case of this embodiment, the column lift 44 is of a vertical orientation and is powered electrically by AC or DC current. In particularly, the column lift 44 may be powered by a 24 VDC battery, or 110 VAC. Column lift 44 includes a piston that raises and lowers relative to the housing. Lift assembly 40 further includes a lifting bar 46. Lifting bar 46 is an elongated bar that extends along the inner side of each side section. As shown in the drawings, the lifting bar 46 includes a series of openings, and wherein the three inner vertical posts 30 project through the openings in the lifting bar 46. Thus, as the lifting bar 46 is moved up and down, the three vertical posts 30 function to align and maintain the lifting bar 46 such that it moves up and down in a vertical plane. Although not shown, disposed within the openings in the lifting bar 46 are bushings that facilitate the vertical movement of the lifting bar about the vertical post 30. Secured along the inner side of the lifting bar 46 is a series of spaced apart hooks 54. Hooks 54 are designed to connect to the auxiliary support.

There is provided a connector between the column lift 44 and the lifting bar 46. Various types of connectors can be utilized. In this case, the connector for each lift assembly 40 includes a plate 48 that is secured to the piston of the column lift 44. A leg 50 depends downwardly from the plate 48 and connects to a connecting flange 52. Connecting flange 52 lies flush against the upper surface of the lifting bar 46 and is secured thereto by bolts, screws, or other suitable fastening means.

The lift assembly 40 and the associated structure is designed to lift what is referred to herein as an auxiliary support which could be a stretcher or other patient support structure. For a complete understanding and appreciation of how this structure can be used, one is referred to my co-pending U.S. patent application Ser. No. 12/963,837 entitled “Patient Lifting Device”, the disclosures found therein being expressly incorporated herein by reference. However, the lift assembly 40 that is mounted on the frame structure 12 can be employed in other ways. For example, the lift structure 40 could be utilized to raise and lower the rollers 180 and its associated structure such as the motors 200 and controllers 220. Essentially the rollers 180 and associated structure is mounted on a moveable frame supported on the frame structure 12. The lift assembly 40 is operatively connected to the moveable frame such that the entire roller assembly could be vertically adjusted.

Each side section includes a series of wheels 60 connected to the lower portion thereof. In the case of the embodiment illustrated herein, each side section includes six wheels, two wheels at opposite ends and two wheels intermediately disposed generally underneath the column lift 44. These wheels 60 enable the side sections to be moved from location to location. In one embodiment, the wheels 60 are castor wheels that facilitate maneuverability.

As alluded to before, each section is connectable to a like side section. This is achieved by a series of adjustable connecting rods. In the embodiment illustrated herein, there are four main connections between the two side sections. There are two connections made at opposite ends at the top of the frame structure 12 and there are two connections made at opposite ends of the frame structure about a lower portion. In order for the frame structure 12 to maneuver over a bed, the lower connecting rod structure on one end of the patient lift device is detachable so as to create an open area about the lower portion of what is referred to as the front end of the patient lift device. See the open area shown about the lower front portion of the patient lift device 100 as depicted in FIG. 2. We have already described the connectors 34 that extend from the right side of the patient lift device 100 as viewed in FIGS. 1 and 2, for example. These connectors 34 are hollow. They receive cooperating connectors 34A that project inwardly from the left side section of the frame structure, as shown in FIGS. 1 and 2. Connectors 34A include a series of openings. Connectors 34 include at least one opening. A connecting pin can be extended through these openings to connect connectors 34 and 34A. As discussed above, in one case, the connector 34 and the mating connector 34A are detachable from the lower front portion of the patient lift device 100.

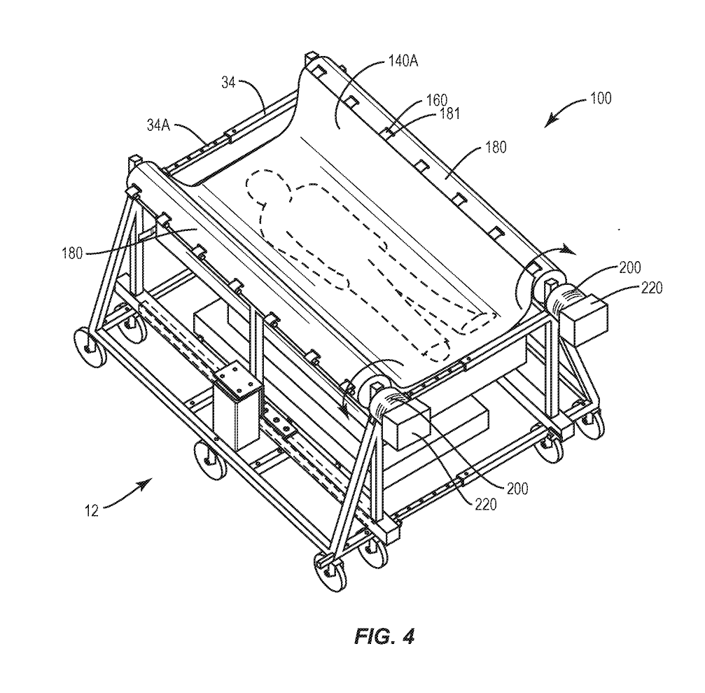

FIG. 1 shows the patient lift device 100 in the retracted position. FIG. 2 shows the patient lift device 100 in an expanded configuration. In FIG. 3, the pliable sheet 140 is disposed over a bed and a patient is lying on the pliable sheet. To retrieve the patient, the connecting bars (34 and 34A) about the lower front portion of the patient lift device 100 are removed. This enables the patient lift device 100 to effectively straddle and move over the bed as shown in FIG. 3. Once positioned over the bed, the loops 160 are connected to the rollers 180. Thereafter, as shown in FIG. 4, the controllers 220 actuate the motors 200 causing the rollers 180 to rotate in counter-directions with respect to each other. See FIG. 4. This causes the loops to roll around the rollers 180 and, in some cases, side portions of the sheet 140A may also roll around the rollers 180. This results in the sheet 140A being raised upwardly and results in the patient being raised off the bed. This is illustrated in FIG. 4. Now the patient lift device 100 can be removed from the bed and the lower front connecting structure can be attached to the frame structure and the patient can be transported to another area in the healthcare facility. The patient lift device 100 makes it easy for the patient to be transferred onto an x-ray table, an MRI table, an operating table, etc. To make such a transfer, the patient lift device 100 can again straddle an underlying table and by rotating the rollers 180 in the opposite direction the patient can be lowered onto another table, bed or other structure.

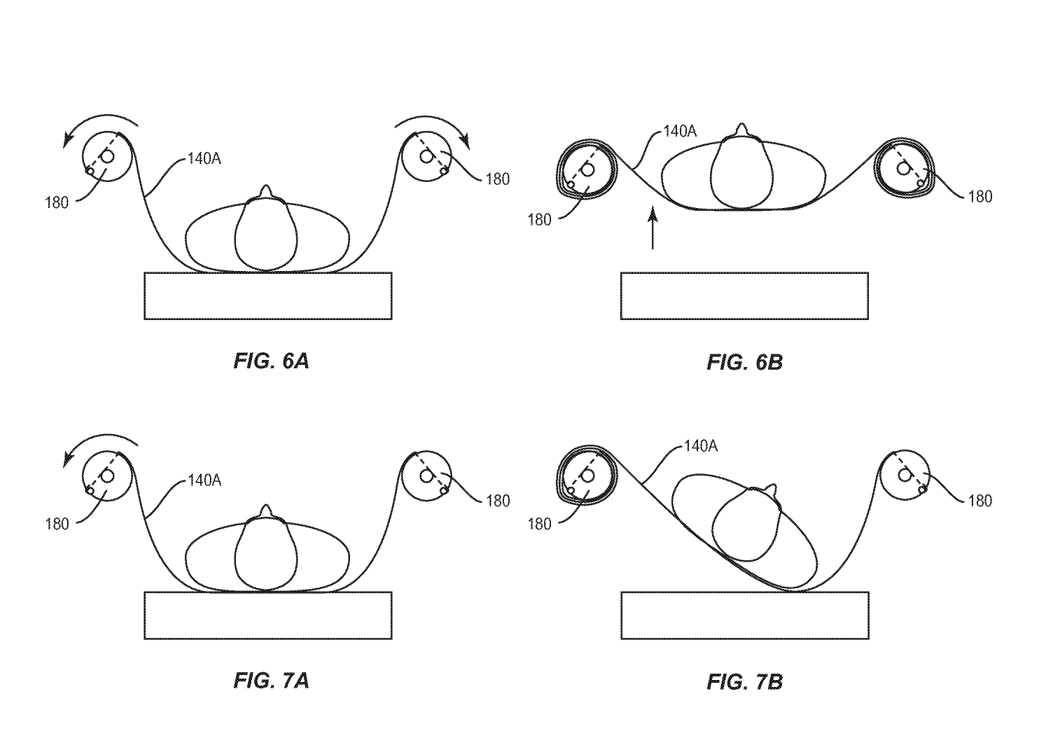

FIGS. 6A and 6B schematically show how the rollers 180 wind the support sheet 140A and lift the patient off an underlying support. In this case, the rollers 180 are turned at the same speed and the same number of revolutions. In FIGS. 7A and 7B, there is schematically shown how the rollers can be utilized to manipulate or turn a patient. In this case, the patient is turned clockwise as viewed in FIGS. 7A and 7B. In order to accomplish this, the right hand roller 180 remains stationery while the left hand roller turns a selected number of revolutions in the counterclockwise direction. This causes a portion of the sheet 140A on the left hand side of the patient to rise and this effectively causes the patient to turn. This procedure can be utilized to turn or at least partially turn the patient and can assist a nurse in turning the patient. In some cases, when turning or manipulating a patient, one of the rollers may not remain stationary. There may be some cases where both rollers are rotated but one roller is rotated more than the other in order to achieve a particular manipulation.

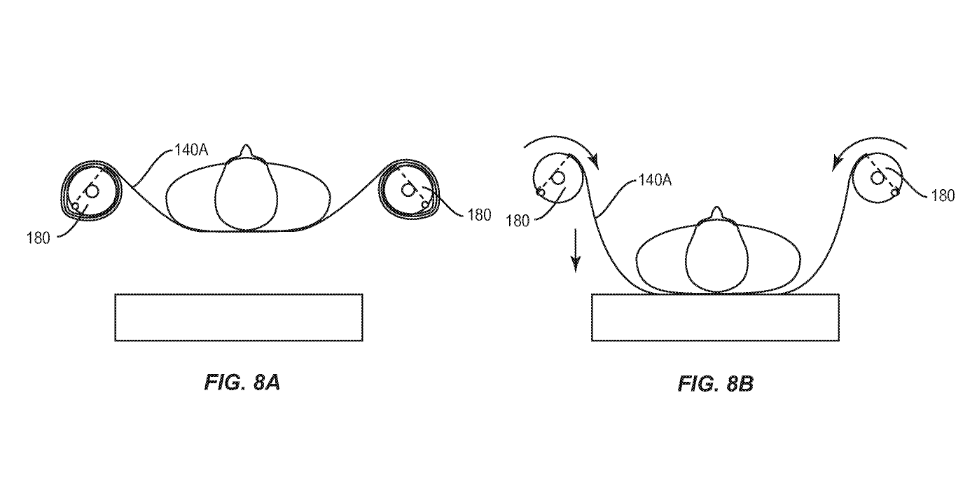

FIGS. 8A and 8B schematically show how the rollers 180 and the sheet 140A cooperate to lower the patient from a raised position. In this case, the rollers 180 are turned in counter-directions towards each other with the left hand roller turning clockwise and the right hand roller turning counterclockwise. This effectively lowers the patient onto the underlying support.

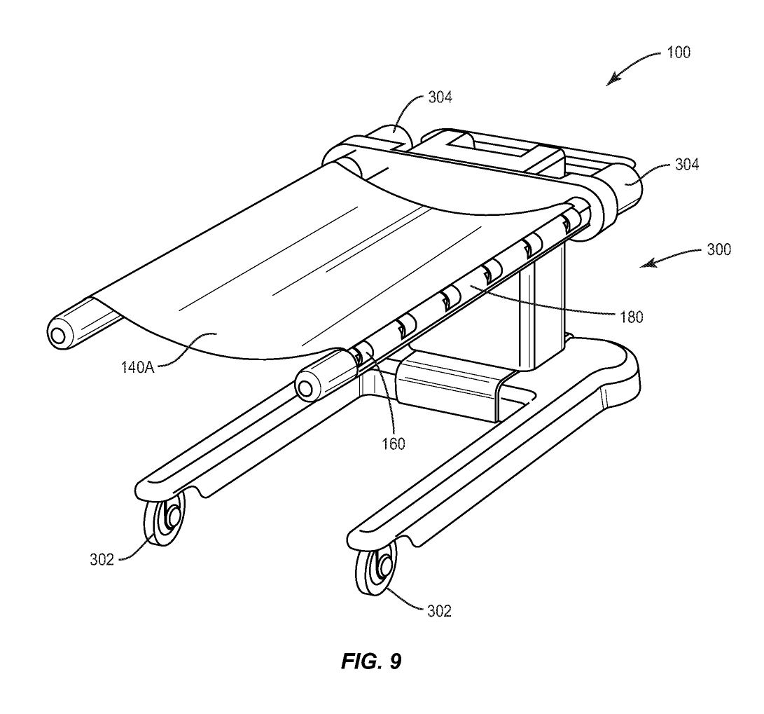

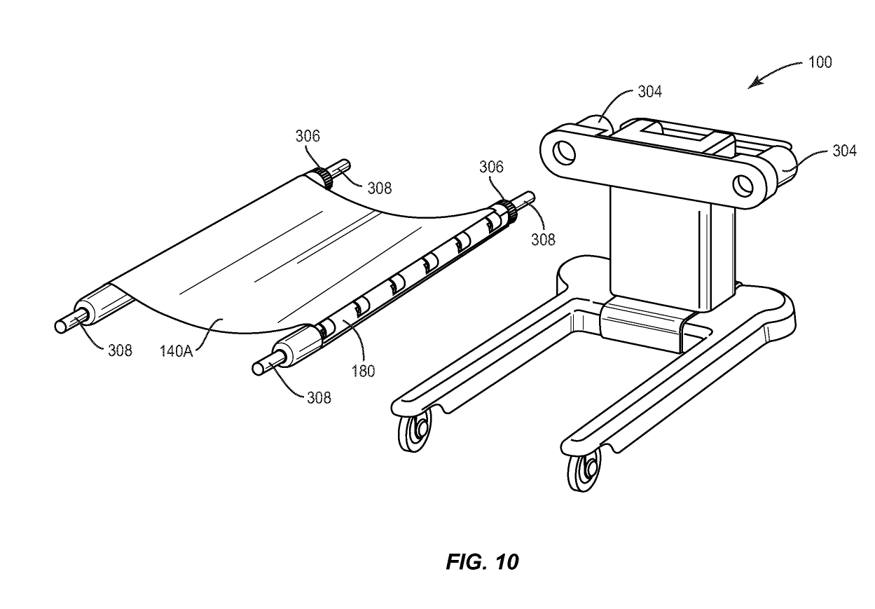

With respect to FIGS. 9 and 10, an alternative embodiment for the patient lifting device 100 of the present invention is shown therein. The patient lifting device shown in FIGS. 9 and 10 operates on the basic principles discussed above with respect to raising and lifting the patient or lowering the patient. As can be seen in FIGS. 9 and 10, the frame structure 300 is designed to support the rollers 180 and the patient support 140A in a cantilevered fashion. That is, the rollers 180 project outwardly from the frame structure 300 and are unsupported about remote ends thereof. Note that the frame structure 300 includes a low profile section that is wheel supported. A pair of wheels 302 are shown about one end of the frame structure 300 and another pair of wheels are disposed on the opposite ends but are concealed by the shroud or housing found at this end of the frame structure. The frame structure 300 includes an upstanding section at one end. This upstanding section supports drive units 304. Each drive unit includes an electric motor and, as an option, could include a controller for controlling the motors.

As illustrated in FIG. 10, the rollers 180 are detachably mounted to the frame structure 300. When detached from the frame structure 300, the rollers 180 include handles 308 that enable the rollers 180 and patient support 140A to be transformed into a stretcher than can be handled by two people stationed at opposite ends.

There are various means that can be employed to appropriately connect the rollers 180 to the drive units 304 when the rollers assume a connected mode. One example is shown in FIG. 10 where on one end of the rollers 180 there is provided a gear 306. When the rollers 180 are properly inserted into openings within the frame structure 300, the gears 306 will engage driving elements or gears associated with the drive units 304. Thus, there is a driving relationship between the drive units 304 and the rollers 180.

One significant feature of the alternative embodiment shown in FIGS. 9 and 10 is that the patient lifting device 100 shown therein can be easily manipulated around a bed having a patient thereon. For example, the low profile nature of the frame structure 300 and the fact that one end thereof is generally unobstructed about a substantial portion thereof enables a patient lifting device to be inserted under a bed having a patient thereon. This results in the rollers 180 projecting over the bed in spaced apart relationship at an elevation at least slightly above the height of the bed. A patient laying on the patient support 140A can be raised by simply connecting the connectors 160 to the rollers 180 and actuating the drive units to raise the patient. Now, the mobile frame structure 300 can be easily removed from the bed area and the patient can be transported to another location.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A patient lifting device for lifting a patient comprising:
a frame structure;
a pair of laterally spaced rollers rotatively mounted on the frame structure;
a pliable patient support for underlying and supporting a patient supported by the pair of rollers;
connectors extending from the pliable patient support and connected to the laterally spaced rollers;
a drive for rotatively driving the rollers;
wherein driving and rotating the rollers causes the patient support to move vertically with respect to the frame structure; and
wherein, in a raised position, the pliable patient support is disposed in an area generally between the two rollers.

2. The patient lifting device of claim 1 wherein the rollers are elongated and extend generally parallel with respect to the patient support.

3. The patient lifting device of claim 1 wherein the connectors include a series of pliable connecting elements and extend from opposite sides of the patient support and wherein the connector elements are connected to the rollers.

4. The patient lifting device of claim 3 wherein the pliable connecting elements and rollers are configured such that, as the rollers are rotated, the pliable connecting elements wind around the rollers or unwind from the rollers.

5. The patient lifting device of claim 3 wherein the pliable connecting elements are threaded through a portion of the rollers.

6. The patient lifting device of claim 1 wherein the rollers are cantilevered from the frame structure.

7. The patient lifting device of claim 1 wherein the rollers are detachably mounted to the frame structure.

8. The patient lifting device of claim 1 wherein the frame structure includes a series of wheels that enable the patient lifting device to be moved from one location to another location.

9. The patient lifting device of claim 1 wherein each roller comprises an elongated cylinder.

10. The patient lifting device of claim 1 wherein the connectors include a series of loops that extend from the pliable patient support and which connect to the rollers.

11. The patient lifting device of claim 10 further including connecting pins that extend through the loop and effectively attach the loops to the rollers.

12. The patient lifting device of claim 10 wherein the rollers include slots and wherein the loops are threaded into and through the slots and wherein the loops are coupled to the rollers.

13. The patient lifting device of claim 1 further including a structure pivotally connected to the frame structure.

14. The patient lifting device of claim 13 wherein the structure is moveably mounted between a horizontal operative position and a vertical inoperative position.

15. The patient lifting device of claim 1 wherein the frame structure and rollers are configured such that the rollers can be projected over a bed.

16. A method of lifting a patient comprising: placing the patient on a patient support having pliable connectors connected to opposite side portions of the support; connecting the connectors to two laterally spaced rollers; and rotating the rollers and winding the connectors on the rollers causing the patient and patient support to be lifted.

17. The method of claim 16 including rotating the rollers in one direction to raise the patient support and rotating the rollers in an opposite direction to lower the patient support.

18. The method of claim 16 including supporting the rollers on a mobile frame.

19. The method of claim 16 wherein the rollers are melted on a mobile frame and the method includes positioning the mobile frame such that the rollers are disposed at an elevation above the patient and placing the patient support underneath the patient and connecting the connectors to the rollers and actuating the rollers so as to wind the connectors onto the rollers, resulting in the patient being lifted upwardly from the bed.

20. The method of claim 16 wherein the rollers are supported in cantilever fashion from a frame structure and the method includes projecting the rollers over a bed that the patient is supported on and placing the patient support under the patient and connecting the connectors to the rollers and rotating the rollers to lift the patient from the bed.

21. The method of claim 16 including selectively rotating the rollers to rotate or turn the patient.
